(19) United States
(12) Patent Application Publication
(10) Pub. No.: US 2014/0147361 A1
(43) Pub. Date: May 29, 2014

(54) Method and Device for Thermal Post-Combustion of Hydrocarbon-Containing Gases

(71) Applicant: C-nox GmbH & Co. KG, Neumünster (DE)

(72) Inventors: Robert Kremer, JR., Aachen (DE); Robert Kremer, SR., Leverkusen (DE); Günther Wietfeld, Neumunster (DE)

(73) Assignee: C-nox GmbH & Co. KG, Neumünster (DE)

(21) Appl. No.: 14/091,491

(22) Filed: Nov. 27, 2013

(30) Foreign Application Priority Data
Nov. 29, 2012 (DE) 10 2012 023 257.8

(51) Int. Cl. B01D 53/44

(52) U.S. Cl. CPC B01D 53/44
USPC 423/245.3; 422/173

(57) ABSTRACT

A method for the thermal post-combustion of waste gases from incomplete combustion or furnace processes, low temperature carbonization gases, landfill gases, smoke gases from ceramic furnace processes, gases from household waste or bio composting facilities, lean gases or other hydrocarbon-containing reducing gases by means of air or other oxidant gases, in which the reducing gas and the oxidant gas are fed separately to the post-combustion in a combustion chamber and thermally post-combusted in the combustion chamber and the reducing gas is heated in a recuperative manner during the supply to the combustion chamber through hot clean gas thermally post-combusted and conveyed out of the combustion chamber, Wherein both the reducing gas as well as the oxidant gas are heated in a recuperative manner flowing parallel via the separate supply to the combustion chamber by the hot clean gas conveyed out of the combustion chamber.

### CROSS-REFERENCE TO RELATED APPLICATIONS

This application claims priority to DE 10 2012 023 257.8, filed on Nov. 29, 2012

### STATEMENT REGARDING FEDERALLY SPONSORED RESEARCH

Not applicable.

### BACKGROUND OF THE INVENTION

The invention relates to a method and a device for thermal post-combustion of hydrocarbon-containing gases under recuperative preheating.

The gases to be post-combusted are in particular biogases, waste gases, low temperature carbonization gases, pyrolysis gases, air discharged from painting facilities, landfill gases, smoke gases from ceramic furnace processes (e.g. release of organic binders in ceramic moulding materials), gases from household waste and bio composting facilities, lean gases or weak-caloric gases (i.e. gases with a small ratio of combustible hydrocarbons) or other generally exothermically oxidizable mixed gases with different caloric content (portion of combustible gas). The gases to be post-combusted contain identical or different hydrocarbons as combustible gas. The combustible gas preferably is or comprises methane.

The gases to be post-combusted are referred to as “reducing gases” or “crude gases” in this application. For the post-combustion or respectively oxidation of the reducing gases, air, oxygen or other gases are used, which are referred to as “oxidant gases” or “oxidizing gases” in this application. The reducing gas preferably does not contain any oxidant gas or contains oxidant gas in such a small portion that it is not combustible without the addition of oxidant gas.

The product of the post-combustion of the reducing gases by means of oxidant gases is referred to as “clean gas” or “waste gas” or “product gas” in this application.

Methods and devices for the cleaning of discharged air by means of the oxidation of gases that contain different amounts of hydrocarbons and, if applicable, carbon monoxide are generally known.

Flare systems and industrial burners are used for the combustion of reducing gas with or without additional enrichment by hydrocarbon-containing gases such as natural or propane gas. The reducing gas is not preheated before the combustion.

These devices are used in particular in emergency mode. This is the case for example in a biogas system when the combustion motor or the gas turbine or steam turbine fails or respectively needs to be serviced. Continuously generated biogas then needs to be flared in that it is combusted with its own caloric content or with added natural or propane gas or other hydrocarbon-containing gas if its own caloric content is too low.

Similar, simple devices are also used as “thermal afterburners” for furnace waste gases, if e.g. remains of unburned hydrocarbons in the furnace waste gas of a brick kiln, which already exit the furnace at an increased temperature, need to be post-combusted.

These simple flare and burner systems for thermal post-combustion always push the limits of their usability in the case of low-caloric reducing gases when the costs for the additional use of combustion gases for operating the systems require the mandatory pre-heating of the reducing gases.

Systems for the thermal post-combustion of low-caloric gases with pre-heating of the reducing gases are differentiated into:
thermally oxidizing systems with regenerative pre-heating of the clean gas (TPC—Thermal Post-Combustion) or (RPC—Regenerative Post-Combustion). The temperature of the combustion chamber hereby usually lies above 780° C.;
thermally oxidizing systems with recuperative pre-heating of the clean gas (RTO—Recuperative Thermal Oxidation). The temperature of the combustion chamber hereby also usually lies above 780° C.;
catalytic post-combustion (CPC), in which the necessary temperature for the oxidation of the clean gas is reduced catalytically. A combustion chamber temperature of 300 to 400° C., depending on the type and content of the clean gas to be oxidized, suffices here, wherein the actual oxidation takes place less through combustion than in the catalytic converter itself of respectively in the catalyst carrier.

A pre-heating of the clean gas takes place in the two named thermal processes of post-combustion via the energy content of the clean gas by means of heat exchangers, on one hand regeneratively by means of heat storage (TPC/RPC) and on the other hand recuperatively by means of heat exchangers (RTO).

Both thermal systems contain a combustion chamber, in which the actual post-combustion takes place at a regulated temperature. The required temperature in the combustion chamber at the start and during operation of the post-combustion is normally achieved through use of a separate gas burner. In order to minimize the output of the burner, the reducing gas is preheated in the following manner:

In the case of regenerative thermal post-combustion (TPC/RPC), the heat exchange is based on the alternating flow of hot clean gas from the thermal post-combustion and cold reducing gas through ceramic honeycombed bodies or fillings. The hot clean gas emits heat to the honeycombed bodies or fillings, which is received by the reducing gas. The advantage of the regenerative thermal post-combustion is the high thermotechnical efficiency with respect to the preheating of the reducing gas. In the case of a combustion chamber temperature of around 800° C., the temperatures of the reducing gas achieved through preheating are up to 780° C., which corresponds to an attainable efficiency of the reducing gas preheating of 90 to 98%. One application of this technique is described in DE 101 49 807 B4, the entire contents of which is incorporated herein by reference, based on the example of the post-combustion of gases from household waste composting.

The disadvantages of the regenerative thermal post-combustion are first the considerable apparatus-based effort for the redirection or respectively changeover of reducing gas and clean gas. This usually takes place through hot flap systems. Alternatively, it takes place in the case of so-called “rotary distributors” through the rotation of a distributor, which is arranged below the cylindrical heat exchanger, which is divided into circular segments. An example of such a regenerative thermal post-combustion with rotary distributor is described in DE 199 50 891 C2, the entire contents of which is incorporated herein by reference.

Another fundamental disadvantage of the regenerative thermal post-combustion is that the high heat capacity of the heat exchanger structures in the individual columns results in a very slow startup behaviour. As a result, these systems are best operated continuously and are difficult to use for discontinuously functioning furnaces and systems.

In contrast, in the case of the recuperative thermal post-combustion (RTO), the reducing gas is preheated via a metallic tube bundle heat exchanger by the hot clean gas and then combusted, as is usual for the TPC, in the combustion chamber at temperatures above 750° C., in general upon addition of fuel and combustion air via a separate burner. The burner types used are surface, nozzle or vortex burners. They heat the reducing gas to be post-combusted to the reaction temperature by means of additional fuels and combustion air, wherein the preheated reducing gas flow is directed into the burner or respectively a flame. In the case the regenerative preheating of the reducing gas, a preheat temperature of the clean gas of under 500° C. is achieved, due to the use of metallic tube bundle heat exchangers. As a result, the energetic efficiency (solely with respect to the potential preheating of the clean gas) is a maximum of 70% so that the additional expense for primary energy for known recuperative thermal post-combustions is higher than for regenerative systems.

Catalytic post-combustions (CPC) are aimed at an oxidation process at low temperatures, wherein the reducing gas can also be preheated in a recuperative or regenerative manner. The oxidation takes place by means of catalytic converters (preferably with platinum-coated hollow body structures, e.g. honeycombed bodies or fillings) typically at temperatures between 300° C. and 400° C. However, the catalytic post-combustion pushes its limits quickly both with respect to capacity of the systems as well as with respect to the type and quantity of the pollutant content in the reducing gas. Large mass flows of reducing gas to be post-combusted are namely almost never post-combusted catalytically. Moreover, catalytic converter gases, such as halogens, heavy metals, silicones, sulphur, can impair the function of the catalytic converter as well as plug or respectively soot up the fine channels during condensation of certain substances such as waxes in the catalyst medium. Today, catalytic post-combustion has by far not reached such broad usage as the two thermal post-combustion types with reducing gas preheating. However, it is being mentioned here not only for the sake of completeness but also with respect to fact that the use of catalytically working substances and substance structures is generally possible in the case of the present invention and thus the necessary temperature in the combustion chamber can also be lowered in an entirely catalytic manner.

Examples of all named types of post-combustion can be found in the brochures of KBA Metal Print GmbH (www.kba-metaiprint.com). They describe on one hand typical regenerative thermal post-combustions (called “thermal-regenerative systems, TRS”) of the known design, in which only the reducing gas to be post-combusted with the thermally post-combusted clean gas can regeneratively exchange the heat in a design-dependent manner. The necessary combustion air is also hereby delivered via a burner flowing into the combustion chamber.

Furthermore, the brochures from KBA Metal Print GmbH describe a recuperative working, horizontally arranged system for thermal post-combustion with the name “TPC—thermal recuperative air purification”. The reducing gas to be combusted is hereby first routed around the tube of a heat exchanger by means of guide surfaces, then supplied to burner in a coaxial double jacket around the combustion chamber. There, the reducing gas is sucked and combusted by the flow of a surface burner. The hereby occurring clean gas exits the combustion chamber through the tube of the heat exchanger and transfers the heat to the reducing gas being routed past the tubes. The surface burner must also be operated with natural gas and combustion air here and the combustion gas is supplied via the burner.

Further disadvantages of the recuperative system are founded through the horizontal setup of the system and of the tube bundle heat exchanger. This namely easily leads in the medium term to deposits in the horizontal tubes of the heat exchanger with accompanying losses in efficiency up to a plugging of the horizontal tube of the heat exchanger. Based on the thermal within the tube bundle heat exchanger, considerably different temperatures must arise in the lower and upper areas (lower—colder, upper—warmer). The thermomechanical stress on the horizontal tube can lead in the medium term to a deformation of the tube.

Furthermore, the design of the tube bundle heat exchanger with tube plates arranged on both sides is disadvantageous. The tube plate facing the combustion chamber or respectively the burner flame is namely exposed to extreme thermal and corrosive stress. Due to the thermal expansion of the tube in the tube bundle and the considerably different temperatures in the lower and upper areas of the horizontal tube bundle, considerable mechanical stress on the welded joints can occur. These can lead in the medium term to leaks between the tube ends and the tube plate so that non-combusted clean gas in the short circuit can flow directly through the tube plate into the tube ends and can thus contaminate the clean gas.

Against this background, the object of the invention is to create a method and a device for the thermal post-composition of hydrocarbon-containing reducing gases, which are more easily realizable and have improved thermal efficiency.

### BRIEF SUMMARY OF THE INVENTION

In the case of the method according to the invention for the thermal post-combustion of waste gases from incomplete combustion or furnace processes, low temperature carbonization gases, landfill gases, smoke gases from ceramic furnace processes, gases from household waste or bio composting facilities, lean gases or other hydrocarbon-containing reducing gases by means of air or other oxidant gases, the reducing gas and the oxidant gas are fed separately to the post-combustion in a combustion chamber and thermally post-combusted in the combustion chamber and the reducing gas is heated in a recuperative manner during the supply to the combustion chamber through hot clean gas thermally post-combusted and conveyed out of the combustion chamber, characterized in that both the reducing gas as well as the oxidant gas are heated in a recuperative manner via the separate supply to the combustion chamber by the hot clean gas conveyed out of the combustion chamber.

The device according to the invention for the thermal post-combustion of waste gases from incomplete combustion or furnace processes, low temperature carbonization gases, landfill gases, smoke gases from ceramic furnace processes, gases from household waste or bio composting facilities, lean gases or other hydrocarbon-containing reducing gases by means of air or other oxidant gases has a combustion chamber, which has separate inlets for reducing gas and oxidant gas and an outlet for thermally post-combusted hot clean gas, and at least one recuperative heat exchanger with at least one primary-side flow channel, the inlet of which is connected with the outlet for hot clean gas from the combustion chamber, and at least one secondary-side flow channel, which has an inlet for the reducing gas and an outlet, which is connected with the inlet of the combustion chamber for reducing gas, characterized in that the recuperative heat exchanger has both at least one secondary-side flow channel for the reducing gas as well as at least one secondary-side flow channel for the oxidant gas, which has an inlet for the oxidant gas and an outlet, which is connected with the inlet for the oxidant gas of combustion chamber.

The object is solved in the case of the method according to the invention and the device according to the invention in that in contrast to regenerative or recuperative thermal post-combustion systems normally used today, a recuperative thermal post-combustion of hydrocarbon-containing reducing gases is performed, the special characteristic of which is the preheating both of the reducing gas as well as of the oxidant gas by the clean gas from the post-combustion.

The preheating of the reducing gas and of the oxidant gas is preferably performed in at least one heat exchanger. The heat exchanger has at least one primary-side flow channel, through which hot clean gas is fed. The clean gas enters the primary-side flow channel through an inlet and exits the primary-side flow channel through an outlet. Furthermore, the heat exchanger has at least one secondary-side flow channel for reducing gas. The secondary-side flow channel for reducing gas is separated from the primary-side flow channel by a heat-conducting wall. The reducing gas enters the secondary-side flow channel through an inlet and exits it through an outlet. On the way through the secondary-side flow channel, it receives heat from the clean gas from trough the heat-conducting wall. Furthermore, the at least one heat exchanger has at least one secondary-side flow channel for oxidant gas. The secondary-side flow channel for oxidant gas is separated from the primary-side flow channel by a heat-conducting wall. The oxidant gas enters the secondary-side flow channel through an inlet and exits it through an outlet. On the way through the secondary-side flow channel, it receives heat from the clean gas from trough the heat-conducting wall. The preheating of the reducing gas and oxidant gas is preferably performed in a joint heat exchanger, which has at least one primary-side flow channel for clean gas as well as at least one secondary-side flow channel for reducing gas as well as at least one secondary-side flow channel for oxidant gas. Alternatively, the preheating of the reducing gas and oxidant gas is performed in separate heat exchangers, one of which has at least one primary-side flow channel for part of the clean gas and at least one secondary-side flow channel for the reducing gas and the other of which has at least one primary-side flow channel for another part of the clean gas and at least one secondary-side flow channel for the oxidant gas.

The combustion chamber comprises a combustion chamber, which is separated from the surrounding area by one or more walls and in which the post-combustion is performed. The combustion chamber is preferably separated from the surrounding area on all sides by one or more walls. The combustion chamber is only open at the outlet for the clean gas as well as the inlets for the reducing gas and the oxidant gas. If applicable, a gas burner or another firing device and/or a temperature sensor and/or at least one other sensor is inserted into the combustion chamber through at least one wall of the combustion chamber. The combustion chamber is also called “firing space” in this application.

Thus, the decisive advantage of the invention is also that not only the clean gas is heated to temperatures slightly below the necessary oxidation temperature in the combustion chamber by the clean gas but rather the oxidizing gas necessary for oxidation (normally the combustion air) is also heated to a similarly high temperature in the heat exchanger in the same manner, whereby the efficiency of this recuperative heat exchanger is considerably higher than in the recuperative systems known today.

For example, if one assumes a clean gas with approx. 10% methane and 90% nitrogen, then the combustion air amount required for complete oxidation is approximately the same as the amount of clean gas. While known systems of thermal post-combustion can now only heat the clean gas to temperatures at best slightly below the combustion chamber temperature, while the combustion air must be fed to the combustion chamber separately “from outside” via a burner, the newly introduced concept is able to preheat both approximately same-sized mass flows in a recuperative manner to temperatures slightly below the combustion chamber temperature.

For high-caloric clean gases with even considerably higher ratios of methane or other hydrocarbons, the named advantage of the system-intrinsic air preheating applies to an even greater degree since here the quantities of air necessary for oxidation are much higher: In the extreme case of the combustion of pure natural gas, ten times the amount of air is needed for complete oxidation. Even if a preheating of the combustion air outside the actual reactors were provided in regenerative or recuperative systems of today's design, this external air/exhaust air heat exchanger could only heat the combustion air to a maximum of 400° C. since on one hand today's burner systems can barely withstand hotter combustion air in terms of their material, but in particular no waste gas flow with a correspondingly high temperature is even available for the heat exchange.

According to a preferred embodiment of the invention, the two educt gases of the oxidation reaction are fed to the combustion chamber through separate tubes and heater around the tubes by opposite-flowing clean gas. In this application, the term “tube” is used to describe elongated hollow bodies with a circular, elliptical or polygonal contour on the outer perimeter and/or on the inner perimeter. The tubes preferably have a circular outer perimeter and a circular inner perimeter. According to one embodiment, the tubes on the outer perimeter and/or on the inner perimeter are provided with lengthwise-aligned ribs.

Through the use of a new type of heat exchanger open towards the reaction space, made of fire-resistant tubes, both the reducing gas as well as the necessary oxidant gas, for example air, are fed separately to a reaction space and combusted there in the simplest manner. The hot clean gas flow is then diverted in the combustion chamber and fed back around the tubes in the counterflow whereby the recuperative heat exchange of hot clean gas to both cooler educt gases is realized.

The simple construction with ending tubes of the heat exchanger open towards the combustion chamber bypasses in particular the big problem that generally exists for straight-tube bundle heat exchangers of the different heat expansion of individual tubes in the case of simultaneous mounting in two tube plates, one each on the inflow side and one on the outflow side:

Since the tubes in an advantageous embodiment of the invention are only held, fastened or welded on the cold inflow side on a perforated plate (also called “clean gas distributor plate” or respectively “air distributor plate”), they can expand in length in any manner into the firing space or contract during cooling without thereby transferring tensile stress or compressive stress amongst each other.

This design of the heat exchanger enables a high heat expansion and thus operation at high temperatures without damaging the structure. A high efficiency of the recuperative heat exchanger is hereby promoted.

According to a preferred embodiment, at least the sections of the tubes of the heat exchanger flowing into the combustion chamber are made of a highly temperature-resistant material. The highly temperature-resistant material is preferably to be created such that it withstands temperatures of at least 780° C. According to a preferred embodiment, gas-tight, silicon-infiltrated silicon carbide (SiC) is used as the highly temperature-resistant material. According to a preferred embodiment, only sections of the tubes are made of the highly temperature-resistant material. But the invention also relates to embodiments in which the tubes are made entirely of the highly temperature-resistant material.

This embodiment of the heat exchanger enables operation at high temperatures without damaging the structure. This also promotes a high efficiency of the recuperative heat exchanger.

Overall, an especially high efficiency of the recuperative thermal post-combustion is enabled through the combination of the preheating of reducing gas and oxidant gas in a heat exchanger with tubes arranged in a freely expandable manner in the longitudinal direction and the implementation of the tubes from a highly temperature-resistant material.

According to a further embodiment, the combustion chamber and the heat exchanger are combined structurally into one unit, which is also called the “reactor” in this application.

In order to start the recuperative post-combustion according to the invention, according to a further embodiment, an electrical resistance heater or another heating device and/or a gas burner or another firing device is provided for the heating of the combustion chamber to a temperature above the ignition temperature of the educt gas mixture.

According to a further embodiment, the oxidizing gas, i.e. normally the combustion air, is first fed to the preheated combustion chamber during the start procedure of the two educt gases, it is briefly rinsed to avoid deflagrations and only then the reducing gas to be post-combusted is added slowly with increasing volume flow until the hot clean gas created during the combustion preheats the educt gases in the counterflow until the exothermal combustion of the reducing gases in the combustion chamber suffices to stabilize the required process temperature in the firing space.

For the purpose of the pressure and temperature regulation of the reactor as well as for the energy decoupling at a high temperature level, according to a further embodiment, a part of the clean gas flow at firing space temperature is branched in a regulated manner directly out of the firing space so that the exothermal reaction occurring in the firing space can only be used partially for the preheating of the educt gases in the counterflow, but also partially directly in the downstream energy converters. According to a further embodiment, a valve is connected with the firing space for this. This is provided e.g. a fire-proof flap with a regulatable cross-section or respectively an opening in a wall of the combustion chamber of the reactor that is regulatable in the opening cross-section.

In the case of extremely low shares of combustible hydrocarbons in the reducing gas to be oxidized, in which the exothermal combustion reaction is insufficient despite the recuperative preheating of the educt gases, in order to safely reach and hold the temperature necessary for the process in the firing space, it is provided according to a further embodiment to enrich the reducing gas before entry into the heat exchanger tube with a combustion gas like natural gas or propane in small amounts in order to let the process proceed in a stable manner at a sufficiently high temperature. Alternatively, it is of course also possible to heat the firing space directly by means of an electric resistance heater or another heating device and/or a separate gas burner or another firing device also beyond the start phase and to permanently regulate the necessary process temperature.

For the ratio regulation between reduction and oxidant gas, it is provided according to a further embodiment a lambda measurement is provided as the control variable, which determines the oxygen concentration in the clean gas and regulates oxygen contents greater than 0.5 vol.% oxygen in the waste gas (clean gas).

In order to increase the heat transfer from the clean gas (product gas) to the tubes, through which the educt gases should fed and heated separately, the multiple diversion of the clean gas flow through fire-proof baffles is provided according to a further embodiment such that the clean gas flow around the tubes is diverted transversely or respectively diagonally to the tubes at least partially from a parallel flow along the tube into a cross flow. According to a further embodiment, the baffles are tube plates and the tubes extend through the holes of the tube plates and are supported laterally.

In cases in which the caloric content of the clean gas allows a heating decoupling from the thermal post-combustion, it is provided according to a further embodiment to branch the pure at a high temperature level directly out of the combustion chamber and to use it for energy conversion in downstream gas or steam turbines, Stirling engines, steam engines or other heat engines.

In order to optimize the thermal oxidation of the respective clean gas to be post-combusted, it is provided according to a further embodiment to adjust the volume of the firing space for the respective volume flow of the educt gases to be combusted in order to thus comply with the respective required holding time for the thermal oxidation.

Moreover, it is provided according to a further embodiment to direct the clean gas exiting the combustion chamber before entering the heat exchange first through an openly porous, ceramic layer, which on one hand minimizes the direct thermal radiation from the combustion chamber into the area of the heat exchanger, on the other hand also ensures for an optimization of the combustion that took place in the firing space in that in its pore structure intentionally strong swirling at a simultaneously high temperature finally completes the oxidation of the reducing gas. It is also possible here to coat this openly porous, ceramic layer catalytically so that a decrease in the oxidation temperature is sought.

Further characteristics and advantages of the newly introduced, recuperatively functioning device for thermal post-combustion are:

The simple controllability of the device, since here no (hot) gas flows need to be constantly diverted in a direction-changing manner as with regeneratively functioning systems

In contrast to the known TPC, not only the clean gas to be cleaned thermally by the off-flowing clean gas, but also a volume flow adjusted to the respective clean gas to be combusted of the combustion air necessary for the oxidation can be heated so that a maximum of even reachable educt gas preheating is realized with the simplest means. For this purpose, the number of the heat exchanger tubes or respectively the sum of the respectively open flow cross-sections should be separated on one hand for the combustion air and on the other hand for the clean gas according to the expected volume flow for a complete combustion.

According to a preferred embodiment, the device according to the invention for thermal post-combustion has the following characteristics:

a thermally insulating reactor.

a heat exchanger made up of straight tubes,

which are guided and held each by one distributor space for the reducing gas

and for the oxidant gas

by respective perforated plates

so that the reducing gas to be combusted and the oxidizing gas are guided separately by the tubes arranged parallel to a combustion chamber, into which the tubes empty with their open end. From the combustion chamber, the then thermally post-combusted clean gas is directed partially to the recuperative preheating of the educt gases in the cross and/or counterflow around the tubes of the tube bundle to an outlet; the other part is diverted directly out of the opening in the combustion chamber.

According to a further embodiment, a second outlet for hot clean gas from the combustion chamber with a valve for setting the mass flow of the clean gas flowing out of the second outlet is present in order to regulate the hot clean gas removed from the combustion chamber. According to a further embodiment, the valve has a fire-proof sealing plug, which is arranged in a displaceable manner in an opening in the wall of the combustion chamber in the direction perpendicular to the opening in order to set the free opening cross-section of the opening and thus the mass flow of the clean gas flowing out of it. Alternatively, the second outlet for the regulation of the mass flow of the removed clean gas is connected with an adjustable flap valve. The clean gas can be directed through a tube system connected with the valve to an energy converter.

It is provided in the preferred embodiment to arrange the reactor as well as the tubes vertically (vertically standing) so that the flow of cold educt gases from bottom to top through the tubes, the off-flowing of the hot, combusted clean gas in contrast in the counterflow around the tubes from top to bottom takeseduct gas place, wherein the clean gases are advantageously diverted through temperature-resistant baffles also for the transverse approaching flow towards the tubes. Through this vertical arrangement, the pressure loss in the heat exchanger is reduced in a natural manner since the educt gases to be heated of the natural convection subsequently flow upwards, while the cooling clean gas flows downward.

It is furthermore provided that the sections of the tubes of the tube bundle arranged in the lower, cold end of the heat exchanger are made of stainless steel tubes, which can easily be welded in a gas-tight manner or screwed into a perforated plate of the distributor space for the reducing gas and into a perforated plate of the distributor plate for the oxidizing gas.

Gas-tight silicium-infiltrated silicium carbide (SiSiC) is suggested as the optimal substance for the upper sections of the tubes flowing openly into the firing space, which can easily withstand temperatures of up to 1360° C. and which can expand freely in length since the height of the tube ends are not mechanically fixed, whereby stress from heat expansion and different temperatures on and in the tube are minimized to the greatest extent possible.

As a joint between the stainless steel tubes, arranged in the colder area of the heat exchanger and the SiC tubes, which lead to the firing space, it is suggested according to a further embodiment that the SiC tube is connected coaxially approx. 250 mm above the stainless steel tube, is mounted on a collar on the stainless steel tube and is in turn encased in a stainless steel tube welded onto the collar with a height of approx. 250 mm. The SiC tube thus sits on the collar within the second coaxial stainless steel tube and can expand freely in length in any manner in the case of a temperature change.

According to a further embodiment, this coaxial joint between the stainless steel tubes and the SiC tubes is filled with an SiC-based or aluminium-oxide-based ceramic adhesive in the double annular gap so that sufficient gas tightness from the circulating clean gas is created.

In order to optimize the heat transfer from the clean gas to the heat exchanger tube, baffles in the form of fire-proof perforated plates made for example of cordierite are arranged such that they divert the gas flow of the clean gas multiple times. These fire-proof baffles also serve the purpose of holding the heat exchanger tube in its respective position; they thus also serve to mechanically stabilize the tubes of the tube bundle with respect to each other. The baffles should thus have perforated sections, which only encompass the SiC tubes with little play and thus hold the tubes at distance horizontally below each other and the baffles themselves are positioned fixed by overlapping in different heights in the horizontal. The height of the baffles can be fixed for example in that they are placed horizontally on at least two thin ceramic tubes, which are themselves fixed in the insulation of the reactor.

In order to minimize direct thermal radiation from the combustion chamber into the area around the heat exchanger, an open porous ceramic structure, e.g. made of highly porous, calcium hexa-aluminate granulates, is provided according to a further embodiment. This openly porous, ceramic layer borders the lower part of the combustion chamber, into which the open ends of the tubes enter, and also ensures optimization of the combustion taking place in the firing space, in that in its pore structure intentionally strong swirling at a simultaneously high temperature finally completes the oxidation of the reducing gas before the clean gas is directed around the heat exchanger tube in the counterflow or respectively by means of baffles in the cross counterflow to the educt gases.

According to a further embodiment, the reactor has a metallic shell, which is thermally insulated with respect to the firing space and the heat exchanger tubes and is adjusted to the respectively upcoming temperatures, so that the upcoming heat remains in the reactor to the greatest extent possible. This insulation can be made both of fibre materials (glass, ceramic wool or respectively fibres) or alternatively of insulating firebrick or insulating firebrick cement (e.g. a calcium hexa-aluminate lightweight concrete.

According to a further embodiment, the perforated plate arranged on the bottom end of the heat exchanger, onto which the clean gases in the reactor flow before their exit, is provided with an effective thermal insulation so that the perforated plate and the welding points of the tubes are effectively protected from thermal stress and chemically corrosive interference.

According to a further embodiment of the reactor, the lean gas to be post-combusted and/or the combustion air are additionally preheated in that they are directed first within one or respectively two separate double jackets around the insulated reactor to the respective perforated plates with tube transfer and are thus actively cooled on one side of the reactor jacket; on the other hand, both the efficiency is optimized and simple protection from contact with the hot inner reactor jacket is realized in this manner.

Further embodiments of the invention are described hereinafter:
1. A method for the thermal post-combustion of waste gases from incomplete combustion or furnace processes, low temperature carbonization gases, landfill gases, smoke gases from ceramic furnace processes, gases from household waste or bio composting facilities, lean gases or other hydrocarbon-containing reducing gases by means of air or other oxidant gases, in which the reducing gas and the oxidant gas are fed separately to the post-combustion in a combustion chamber and thermally post-combusted in the combustion chamber and the reducing gas is heated in a recuperative manner during the supply to the combustion chamber through hot clean gas thermally post-combusted and conveyed out of the combustion chamber, characterized in that
   both the reducing gas as well as the oxidant gas are heated in a recuperative manner via the separate supply to the combustion chamber by the hot clean gas conveyed out of the combustion chamber.
2. The method according to embodiment 1, in which the reducing gas and the oxidant gas are heated in a recuperative manner until their introduction into the combustion chamber by the clean gas conveyed out of the combustion chamber.
3. The method according to embodiment 1 or 2, in which the reducing gas and the oxidant gas parallel-flowing are heated in a recuperative manner by clean gas conveyed out of the combustion chamber.
4. The method according to one of embodiments 1 to 3, in which the reducing gas and the oxidant gas are heated in a recuperative manner by the same mass flow of the clean gas conveyed out of the combustion chamber.
5. The method according to one of embodiments 1 to 4, in which the reducing gas and the oxidant gas flowing vertically upwards are heated in a recuperative manner by the clean gas conveyed out of the combustion chamber.
6. The method according to one of embodiments 1 to 5, in which the reducing gas and the oxidant gas in their separate supply into the combustion chamber are heated by the clean gas conveyed out of the combustion chamber in the counterflow or in the cross counterflow.
7. The method according to one of embodiments 1 to 6, in which the reducing gas and the oxidant gas in their separate supply into the combustion chamber are preheated to a temperature of at least 600° C., preferably at least 700° C., furthermore preferably at least 750° C., in particular approximately 780° C.
8. The method according to one of embodiments 1 to 7, in which in order to start the post-combustion the combustion chamber is preheated at least to a temperature above the ignition temperature of the educt gas mixture by an electrical resistance heater or another heating device and/or by a gas burner or another firing device in order to start the post-combustion.
9. The method according to embodiment 8, in which, in order to start the post-combustion of the two educt gases, the oxidant gas is first directed into the preheated combustion chamber, briefly rinses it and the reducing gas to be post-combusted is only then added with gradually increasing volume flow until the hot clean gas created during the combustion preheats the educt gas to such an extent that the exothermal combustion of the reducing gas in the combustion chamber suffices in order to stabilize the process temperature required for the post-combustion without support from the heating device or the firing device and the heating device or firing device is then switched off
10. The method according to one of embodiments 1 to 9, in which a second partial flow of the hot clean gas is conveyed out of the combustion chamber separately from a first partial flow of the hot clean gas conveyed out of the combustion chamber for the recuperative heating of the educt gases in order to set the pressure and the temperature in the combustion chamber, and/or the second partial flow of the hot clean gas is fed to a downstream energy converter for conversion of thermal energy into mechanical or electrical energy.
11. The method according to embodiment 10, in which the clean gas conveyed separately out of the combustion chamber is used for energy conversion in at least one of the following energy converters: steam turbine, Stirling engine, steam engine or another heat engine.
12. The method according to embodiment 10 or 11, in which the second mass flow of the hot clean gas is regulated for pressure and temperature regulation in the combustion chamber.
13. The method according to one of embodiments 1 to 12, in which in one case, in which the portions of combustible hydrocarbons in the oxidant gas are so low that the exothermal combustion reaction is insufficient despite the recuperative preheating of the educt gases in order to safely reach and maintain the temperature in the combustion chamber necessary for the combustion process, the reducing gas is enriched before the recuperative heating with natural gas or propane or another combustion gas in order to let the combustion proceed in a stable manner at a sufficiently high temperature.
14. The method according to one of embodiments 8 to 13, in which in one case, in which the portions of combustible hydrocarbons in the oxidant gas are so low that the exothermal combustion is insufficient despite the recuperative preheating of the educt gases in order to safely reach and maintain the temperature in the combustion chamber necessary for the combustion, the combustion chamber is also heated beyond the start phase by means of the heating device or the firing device and is maintained in a stable manner at the necessary combustion temperature.
15. The method according to one of embodiments 1 to 14, in which the mass flows of the reduction and oxidant gases are controlled at a ratio that uses an A/F control as the control variable, i.e. an oxygen concentration in the clean gas, and regulates oxygen contents to at least 0.5 percent by volume of oxygen in the clean gas.
16. The method according to one of embodiments 1 to 15, in which the clean gas from the combustion chamber is conveyed away through an openly porous, ceramic layer, which on one hand reduces the thermal radiation from the combustion chamber into the cableway of the clean gas, on the other hand improves the combustion in the combustion chamber, in that, in its pore structure, a strong swirling at a simultaneously high temperature finally completes the oxidation of the reducing gas before the thermally post-combusted clean gas is fed to the recuperative heating of the educt gases.
17. The method according to one of embodiments 1 to 16, in which the cross-sections of the lines for the supply of the educt gases into the combustion chamber are adjusted to the mass flow ratios of the educt gases in order to heat in an evenly recuperative manner the educt gases and/or in which the volume of the combustion chamber is adjusted to the mass flows of the educt gases in order to ensure the required holding time for the thermal post-combustion of the educt gases.
18. The method according to one of embodiments 1 to 17, in which the recuperative heating of the reducing gas and oxidant gas as well as the post-combustion is performed in an area thermally insulated with respect to the surrounding area and/or in which the post-combustion of the reducing gas is performed in an area optically shielded from the surrounding area.
19. The method according to one of embodiments 1 to 18, in which a post-combustion of the reducing gas is already performed in the last section of the path of the supply of the reducing gas and the oxidant gas into the combustion chamber.
20. The method according to embodiment 19, in which a part of the heat at the temperature level of the post-combustion is transferred to the educt gases via thermal radiation in the last section of the path of the supply of reducing gas and oxidant gas into the combustion chamber.
21. A device for the thermal post-combustion of waste gases from incomplete combustion or furnace processes, low temperature carbonization gases, landfill gases, smoke gases from ceramic furnace processes, gases from household waste or bio composting facilities, lean gases or other hydrocarbon-containing reducing gases by means of air or other oxidant gases with a combustion chamber (2), which has separate inlets (5, 6) for reducing gas and the oxidant gas and an outlet (9) for thermally post-combusted hot clean gas, and at least one recuperative heat exchanger (3) with at least one primary-side flow channel (24), the inlet (10) of which is connected with the outlet (9) for hot clean gas of from the combustion chamber (2), and at least one secondary-side flow channel (14), which has an inlet (5) for the reducing gas and an outlet (7), which is connected with the inlet of the combustion chamber (2) for reducing gas, characterized in that
   the recuperative heat exchanger (2) has both at least one secondary-side flow channel (14) for the reducing gas as well as at least one secondary-side flow channel (15) for the oxidant gas, which has an inlet (6) for the oxidant gas and an outlet (8), which is connected with the inlet for the oxidant gas from the combustion chamber (2).
22. The device according to embodiment 21, in which an inlet (24) of at least one primary-side flow channel (24), which neighbours the outlets (7, 8) of the secondary flow channels (14, 15), is connected with the outlet of the combustion chamber (2) for hot clean gas for operation of the heat exchanger (3) in the counterflow.
23. The device according to embodiment 21 or 22, in which the outlets (7, 8) of the secondary-side flow channels (14, 15) are directly connected with the inlets for educt gases of the combustion chamber (2) and the inlet (10) of the primary-side flow channel (24) is connected directly with the outlet (9) of the combustion chamber (2) for hot clean gas.
24. The device according to one of embodiments 21 to 22, in which the heat exchanger (3) in a housing (13) has parallel, straight tubes (4), of which a first group (14) with its openings on a first end flows into a first distributor space (20) for the reducing gas, which has the inlet (5) for the reducing gas, and with its openings on a second end flows into the combustion chamber (2), of which a second group (15) with its openings on a first end flows into a second distributor space (23) for the oxidant gas, which has an inlet (6) for oxidant gas, and with its openings on a second end flows into the combustion chamber (2), and in which the jacket space (24) between the parallel tubes (4) and the housing (13) on a first end are connected with the combustion chamber (2) via an opening and has on a second end an outlet (11) for cooled clean gas.
25. The device according to embodiment 24, in which the combustion chamber (2) and the heat exchanger (3) are combined into one structural unit.
26. The device according to embodiment 25 in which the combustion chamber (2) is surrounded by a housing (13), which is permanently connected with the housing (13) of the heat exchanger (3) and forms a joint housing (13) with it.
27. The device according to one of embodiments 21 to 26, in which the tubes (4) and/or the housing (13) of the combustion chamber (2) and/or the heat exchanger (3) have a cylindrical and/or a polygonal cross-section.
28. The device according to one of embodiments 21 to 27, in which the combustion chamber (2) has a second outlet (12) for hot clean gas and a valve (29, 30) connected with the second outlet (12) for setting the mass flow flowing from the second outlet (12).
29. The device according to embodiment 28, in which the valve (29, 30) has a fire-proof, conical sealing plug (30) and a conical sealing seat (29) in the second outlet of the combustion chamber.
30. The device according to one of embodiments 21 to 29, in which the combustion chamber (2) and the heat exchanger (3) are thermally insulated.
31. The device according to one of embodiments 21 to 30, in which the heat exchanger (3) with the tubes (4) is arranged vertically so that the flow of the cold educt gases through the tubes (4) takes place from bottom to top and the flow of the hot clean gas through the jacket space (24) from top to bottom.
32. The device according to one of embodiments 21 to 31, in which the heat exchanger (3) in the jacket space (24) has baffles (35) for the transverse approaching flow towards the tubes (4).
33. The device according to one of embodiments 24 to 32, in which the tubes (4) in the heat exchanger (3) are retained on perforated plates (17, 19) and/or are guided in the axial direction through perforated plates (35) and/or baffles are formed by perforated plates (35).
34. The device according to one of embodiments 24 to 33, in which the tubes (4) of the heat exchanger (3) have sections (37), which are made of stainless steel tubes and are welded in a gas-tight manner in holes of perforated plates (17, 19), which border the distributor spaces (20, 23) for the reducing gas and the oxidant gas.
35. The device according to one of embodiments 24 to 34, in which the tubes (4) have two sections (38) flowing into the combustion chamber (2), which are made of gas-tight, silicon-infiltrated silicon carbide (SiC), which preferably withstand temperatures of up to 1360° C. and can freely expand in length since these sections (38) of the tubes (4) are each only fixed at one position in their longitudinal direction and can otherwise freely expand in their longitudinal direction.
36. The device according to one of embodiments 34 and 35, in which the first sections (37) of the tubes (4) made of stainless steel and the second sections (38) of tubes (4) made of SiC are aligned coaxially with each other and are permanently interconnected on one end.
37. The device according to embodiment 36, in which the joint (40) between the first sections (37) of the tubes (4) made of stainless steel and the second sections (38) of the tubes (4) made of SiC comprises a collar (41) protruding outwards from the first sections (37) at a distance from one end and a tube piece (42) welded on the collar (41) made of stainless steel with an annular gap (43) between the tube piece (42) and the first section (37), wherein the second sections (38) with their end areas are inserted into the annular gaps (43) and are mounted on the collar (41).
38. The device according to embodiment 37, in which the second sections (38) are glued into the annular gaps (43) by means of a SiC-based or aluminium-oxide-based ceramic adhesive (44) so that sufficient gas tightness is achieved between tubes (4) and jacket space (24).
39. The device according to one of embodiments 32 to 38, in which the baffles (35) are made of cordierite ceramic, which preferably have a temperature stability up to approximately 1260° C.
40. The device according to one of embodiment 32 or 39, in which the baffles (35) have additional holes (34), which surround the tubes (4) with only little play and thus hold the tubes (4) at distance from each other and permit an expansion of the tubes (4) in the longitudinal direction.
41. The device according to one of embodiments 32 to 40, in which the baffles (35) are aligned horizontally and rest on at least two ceramic tubes, which are themselves fastened on the inside of the housing (13) of the heat exchanger (3) or on the inside of the insulation (45) of the housing (13).
42. The device according to one of embodiments 24 to 41, in which an openly porous, ceramic layer (44) closes a lower part of the combustion chamber (2), into which the tubes (4) with the openings on their first ends flow, on one hand in order to minimize the direct thermal radiation from the combustion chamber (33) into the area around the tubes (4) and one the other hand to improve the combustion taking place in the combustion chamber (33) in that, in the pore structure of the ceramic layer, strong swirlings at a simultaneously high temperature finally complete the oxidation of the reducing gas before the clean gas is conveyed away to the educt gases around the tubes (4) in the counterflow and, if applicable, by means of baffles (35) in the cross counterflow.
43. The device according to embodiment 42, in which an openly porous, ceramic layer made of highly porous calcium hexa-aluminate granulates is constructed.
44. The device according to one of embodiments 21 to 43, which has a metallic housing (13), which is thermally insulated for the combustion chamber (2) and/or for the heat exchanger (3) and adjusted to the respectively upcoming temperatures so that the upcoming heat remains in the housing (13) to the greatest extent possible.
45. The device according to embodiment 44, in which the insulation of the housing (13) is made of glass or ceramic wool or other fibre materials or insulating firebrick or insulating firebrick cement.
46. The device according to embodiment 45, in which the insulation is made of an insulating firebrick cement, the main volumetric component of which is calcium hexa-aluminate and is thus also sufficiently fire-proof for the insulation of the combustion chamber (2) and also has sufficient abrasive and chemical stability with respect to the combustion gases.
47. The device according to one of embodiments 34 to 46, in which the first perforated plate (17) bordering the first distributor space (20), onto which the clean gas flows before exiting the outlet for clean gas, is provided with a ceramic insulation so that the first perforated plate (17) as well as the welding points are protected from thermal stress and chemically corrosive interference.
48. The device according to one of embodiments 21 to 47, in which the combustion chamber (2) has a double jacket (48), which has separated jacket chambers (50, 51), wherein the first jacket chamber (50) has another inlet (52) and an outlet for reducing gas and the second jacket chamber (51) has another inlet (53) and an outlet for oxidant gas and the outlet for reducing gas is connected with the inlet (5) of the secondary-side flow channel for reducing gas of the heat exchanger (3) and the outlet of the oxidant gas is connected with the inlet (6) of the secondary flow channel for oxidant gas of the heat exchanger (3), in order to additionally heat the reducing gas and the oxidant gas before entering the heat exchanger (3) and to cool the combustion chamber (2).
49. The device according to one of embodiments 21 to 48, in which the combustion chamber (2) optically shields the combustion chamber (33) with respect to the surrounding area.
50. The device according to one of embodiments 24 to 49, in which the openings on the second ends of the first and second group (14, 15) of tubes (4) flow into the combustion chamber (2) at the same or at a different level.
51. The device according to one of embodiments 42 to 50, in which the openly porous, ceramic layer (44) has holes for the passage of the reducing gas at the openings on the second end of the first group (14) of tubes (19) for the reducing gas, wherein the opening cross-section of these holes of the ceramic layer (44) corresponds with the opening cross-section of the openings of the tubes (4) of the first group (14).

### BRIEF DESCRIPTION OF THE SEVERAL VIEWS OF THE DRAWINGS

The invention will be further explained with reference to the accompanying drawings of exemplary embodiments. The drawings show in:

FIG. 1 a device for the thermal post-combustion in a vertical cut;

FIG. 2 the arrangement of the tubes of the heat exchanger of the device in perforated plates in a vertical partial cut;

FIG. 3 the arrangement of the lower sections of the tubes of the heat exchanger in perforated plates in a perspective partial view;

FIG. 4 the arrangement of the upper sections of the tubes of the heat exchanger in perforated plates in a perspective partial view;

FIG. 5 the upper section of a tube of the heat exchanger in an enlarged perspective view diagonally from the top and of the side;

FIG. 6a+b connection of the lower section with the upper section of a tube of the heat exchanger before the joining of the two sections (FIG. 6a) and after the joining of the two sections (FIG. 6b) in a longitudinal cut;

FIG. 7a+b connection of the lower section with the upper section of a tube of the heat exchanger before the joining of the two sections (FIG. 7a) and after the joining of the two sections (FIG. 7b) in a perspective view diagonally from the top and from the side;

FIG. 8 an additional device for the thermal post-combustion with additional preheating of the educt gases on the jacket of the combustion chamber in a vertical cut;

FIG. 9 the same device vertically cut in a perspective view diagonally from the front and from the side;

FIG. 10 the same device in a perspective X-ray image diagonally from the top and from the side;

FIG. 11 the same device in a cut through the plane XI in FIG. 10;

FIG. 12 lower section of the tube of a heat exchanger for flexible distribution of clean gas and air to the tubes in a vertical cut;

FIG. 13 the same arrangement in a perspective view diagonally from the top and from the side; and

FIG. 14 the same arrangement in a perspective view diagonally from the bottom and from the side.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

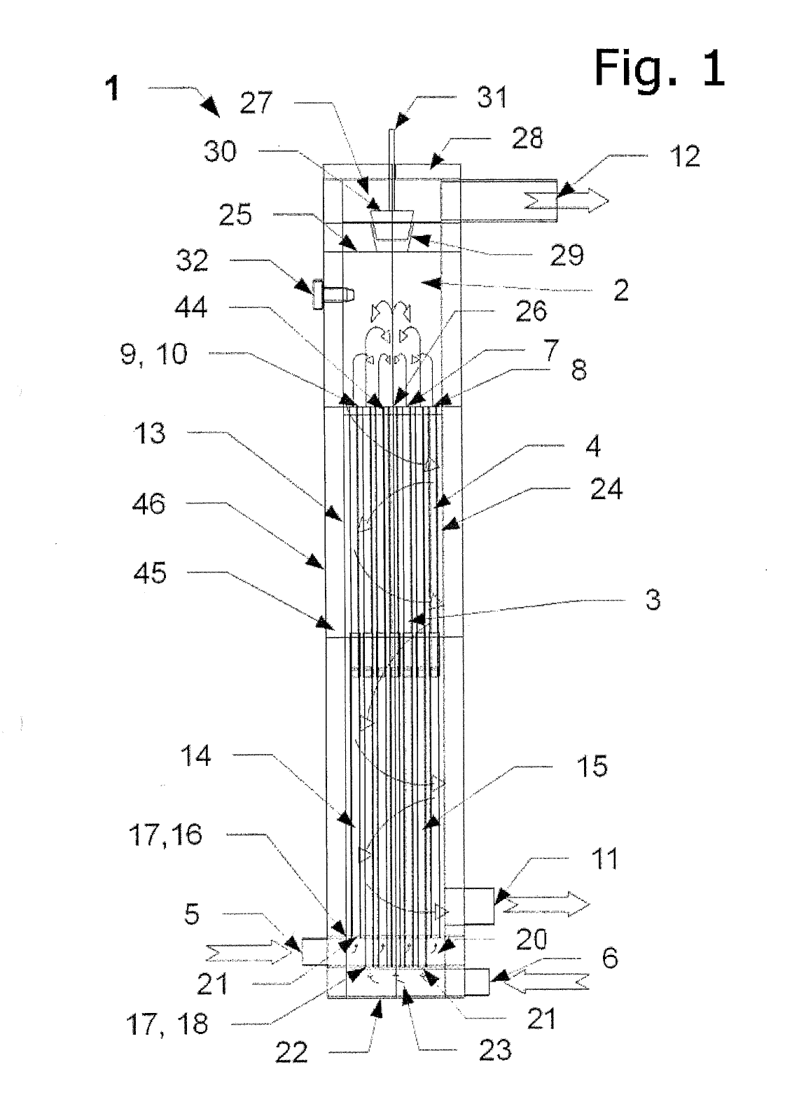

According to FIG. 1, a device 1 according to the invention comprises a combustion chamber 2 and a heat exchanger 3. The heat exchanger 3 is designed as a tube bundle heat exchanger with vertical tubes 4. The combustion chamber 2 is located above the heat exchanger 3.

The heat exchanger has inlets 5, 6 for clean gas and combustion air on the bottom and outlets 7 for heated clean gas and heated combustion air 8 on the top.

The combustion chamber 2 has a first outlet 9 for hot clean gas on the bottom, which is connected with an inlet 10 of the heat exchanger 3 for hot clean gas. On the bottom, the heat exchanger has an outlet 11 for cooled clean gas.

Furthermore, the combustion chamber has a second outlet 12 for hot clean gas on the top.

The combustion chamber 2 and the heat exchanger 3 are structurally combined into one unit by a common housing 13. The unit is also called the “reactor”.

The housing 13 is column-like, wherein it can have a circular or elliptical or polygonal cross-section. In the example, the housing has a rectangular cross-section.

The inlets 5, 6 for clean gas and combustion air as well as the second outlet 12 for clean gas are lead to the outside through the wall of the housing 13.

The tubes 4 of the heat exchanger are aligned parallel to each other in a tube bundle. The tube bundle comprises two groups 14, 15 of tubes 4. The tubes 4 of a first group 14 are inserted and welded on the bottom on their first end into the first holes 16 of a first perforated plate 17, which are aligned vertical to the tubes 4 and arranged slightly above the inlet 5 for clean gas. The first perforated plate 17 is welded on its perimeter with the lateral wall of the housing 13.

The tubes 4 of the second group 15 are inserted on the bottom on their first end into second holes 18 of a second perforated plate 19 and welded with them, which are aligned vertical to the tubes 4 and between the inlets 5, 6 for clean gas and the combustion air. The second perforated plate 19 is also welded on its perimeter with the lateral wall of the housing 13.

The first and the second perforated plate 17, 19 border, together with a section of the lateral wall of the housing 13, a first distributor space 20 for the reducing gas, into which the openings 21 flow on the first ends of the first group 14 of tubes 4.

The second perforated plate 19 borders, together with a bottom wall 22 of the housing 13 and another section of the lateral wall of the housing 13, a second distributor space 23 in which the openings 21 on the first ends of the tubes 4 of the second group 15 flow.

Above the perforated plates 17 and 19, the lateral wall of the housing 13 borders a jacket space 24 of the heat exchanger 3 in which the tubes 4 extend with a distance from each other and with a distance from the lateral wall of the housing 13.

The upper end of both groups 14, 15 of tubes 4 border the combustion chamber 2 at the same time on the bottom. On the perimeter, the combustion chamber 2 is bordered by the lateral wall of the housing 13. On the top, the combustion chamber 2 is bordered by a horizontal upper chamber wall 25, which is welded on the perimeter with the lateral wall of the housing 13.

Openings 16 on the two ends of the tubes 4 thus flow downwards in the combustion chamber 2. The free cross-section in the jacket room 24 between the second ends of the tubes 4 form at the same time the first outlet 9 from the combustion chamber 2 for clean gas and the inlet 10 of the heat exchanger 3 for clean gas.

There is a collection space above the upper chamber wall 25, which is bordered on the perimeter by the lateral wall of the housing and on the top by a cover wall 28 of the housing. The collection space 27 is connected with the second outlet 12 for clean gas.

In the upper chamber wall 25, a valve seating 29 in the form of a conical opening is centrally arranged. A plug 30, which has a corresponding conical form, is arranged in the valve seating 29. The plug 30 can be displaced within the opening 29 by means of a lifting rod 31, which is lead to the outside through the cover wall 28 of the housing 12, so that the free opening cross-section of the opening 29 is adjustable by shifting the position of the plug 30.

A gas burner 32 is inserted from outside into the combustion chamber 33 in the combustion chamber 2 through the lateral wall of the housing 13.

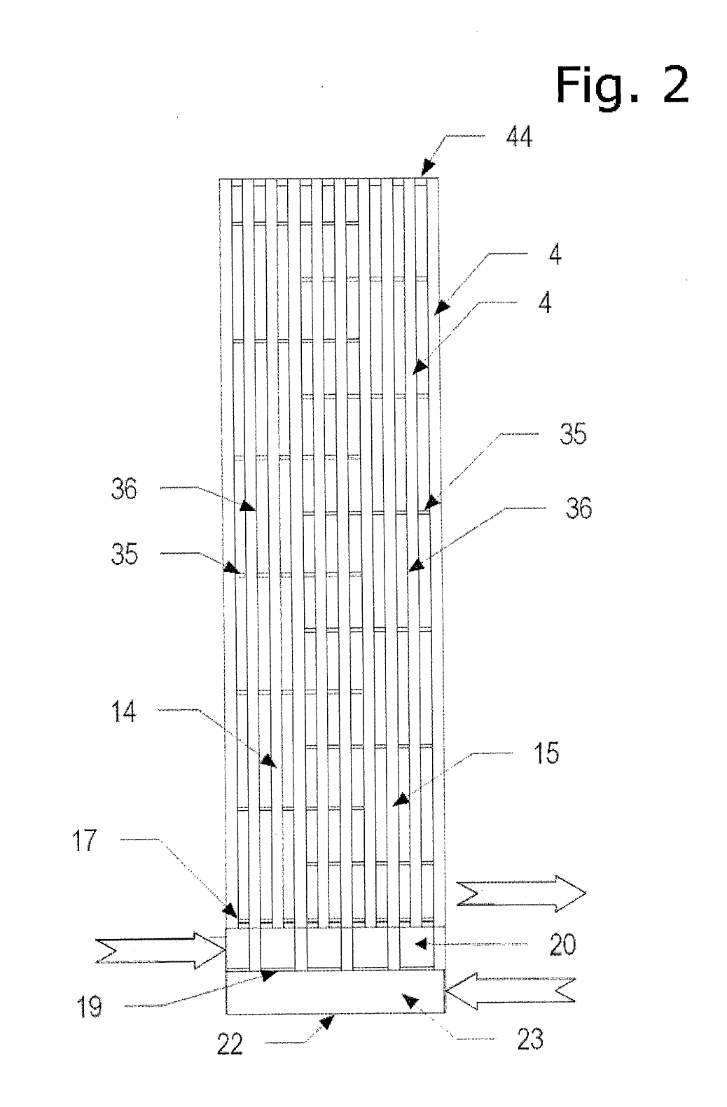

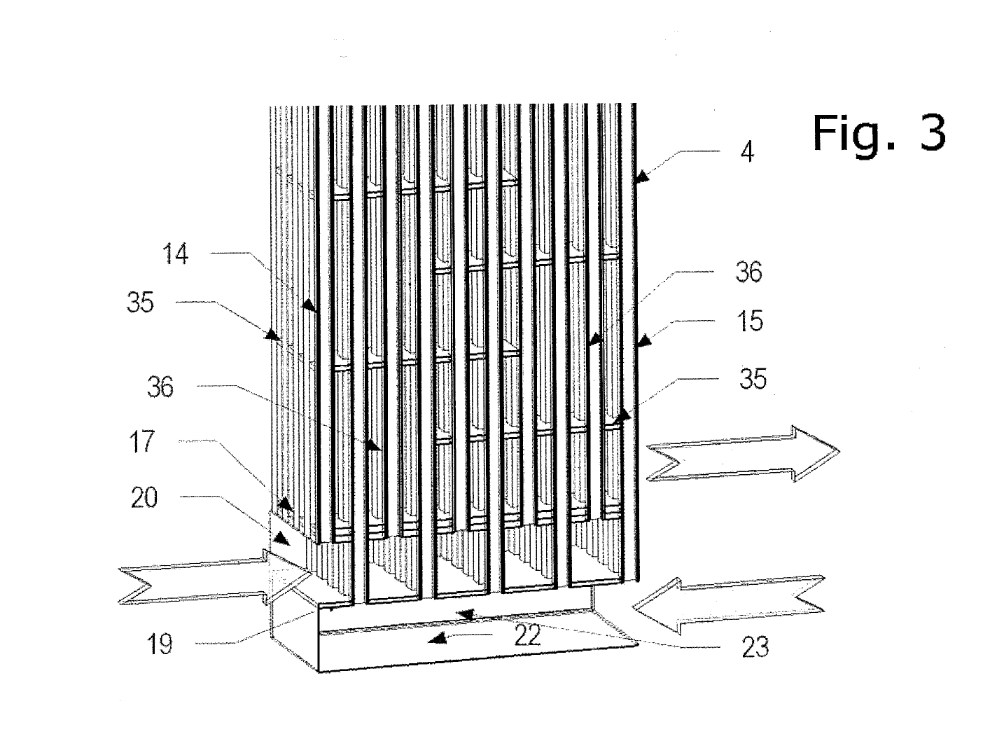

According to FIGS. 2 and 3, the tubes 4 of the two groups above the first and second perforated plates 17, 19 are fed through additional holes 34 in additional perforated plates 35 aligned perpendicular to the tubes 4. The additional perforated plates 35 are held laterally on the lateral wall of the housing 13. The additional perforated plates 35 are arranged at a distance from each other in the longitudinal direction of the tubes 4. They each extend only over a part of the cross-section of the jacket space 24 so that a free cross-section 36 remains next to each additional perforated plate 35 for the flowing through of the clean gas. The free cross-section 36 is arranged from additional perforated plate 35 to additional perforated plate 35 offset on different sides of the housing 13. The additional perforated plates 35 simultaneously form baffles, which direct the mass flow of the clean gas transversely to the tubes.

The outlet 11 for cooled clean gas opens between the first perforated plate 17 and the additional neighbouring perforated plate 35 in the jacket space 24.

The tubes 4 are guided only laterally into the additional perforated plates 35 so that they can expand unhindered in the longitudinal direction and also in the transverse direction when they are heated to operating temperature.

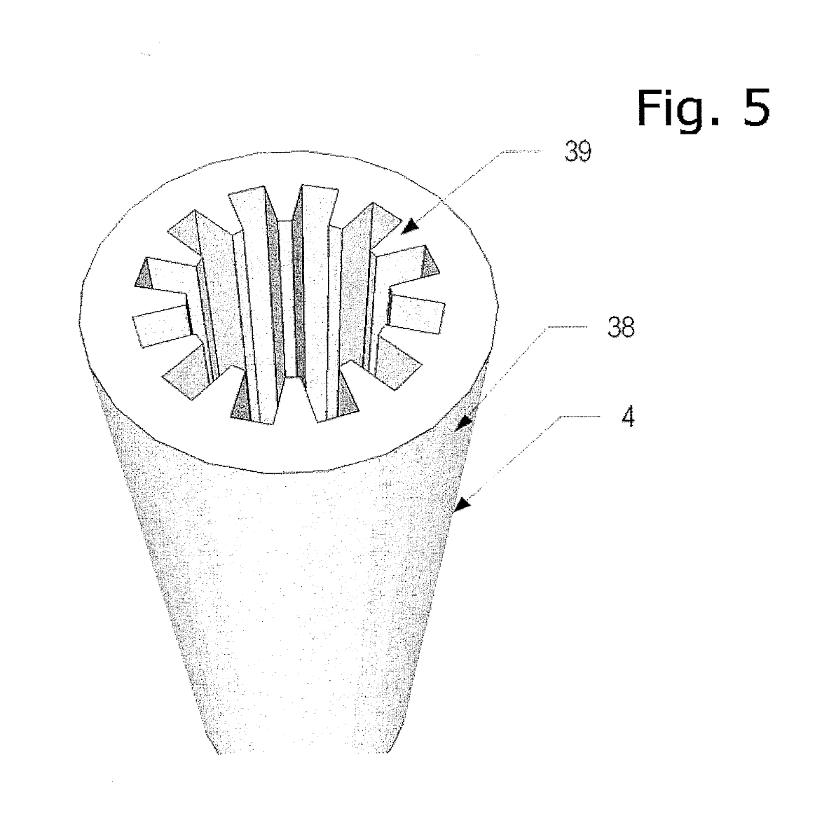

The tubes 4 of both groups 14, 15 each have two sections 37, 38, wherein a first section 37 made of stainless steel is welded with the first or respectively second perforated plates 17, 19 and a second section 38 made of SiC or another highly temperature-resistant material extends up to the combustion chamber 2. The tubes 4 are thus each made of two tubes made of different materials. The tubes of the first section 37 are for example hollow and cylindrical. The tubes of the second section 38 have for example a cross-sectional shape with a circular outer circumference and a circular inner circumference and ribs 39 protruding from the inner circumference and extending in the longitudinal direction of the tubes 4, as shown in FIG. 5.

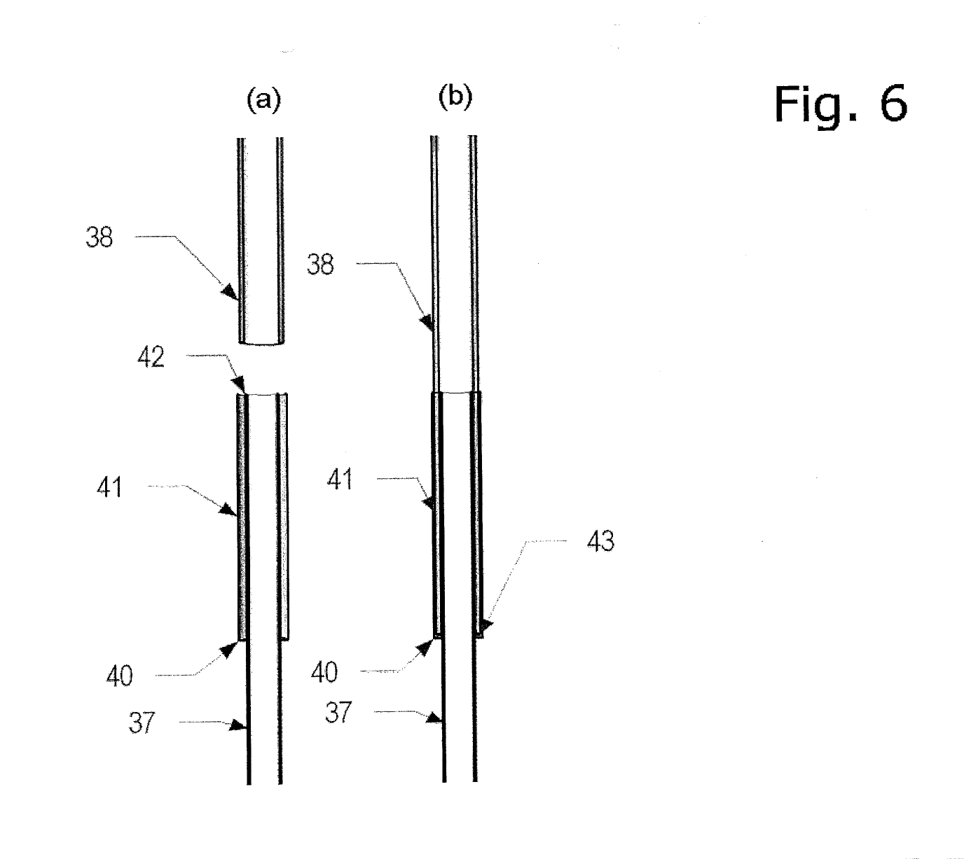

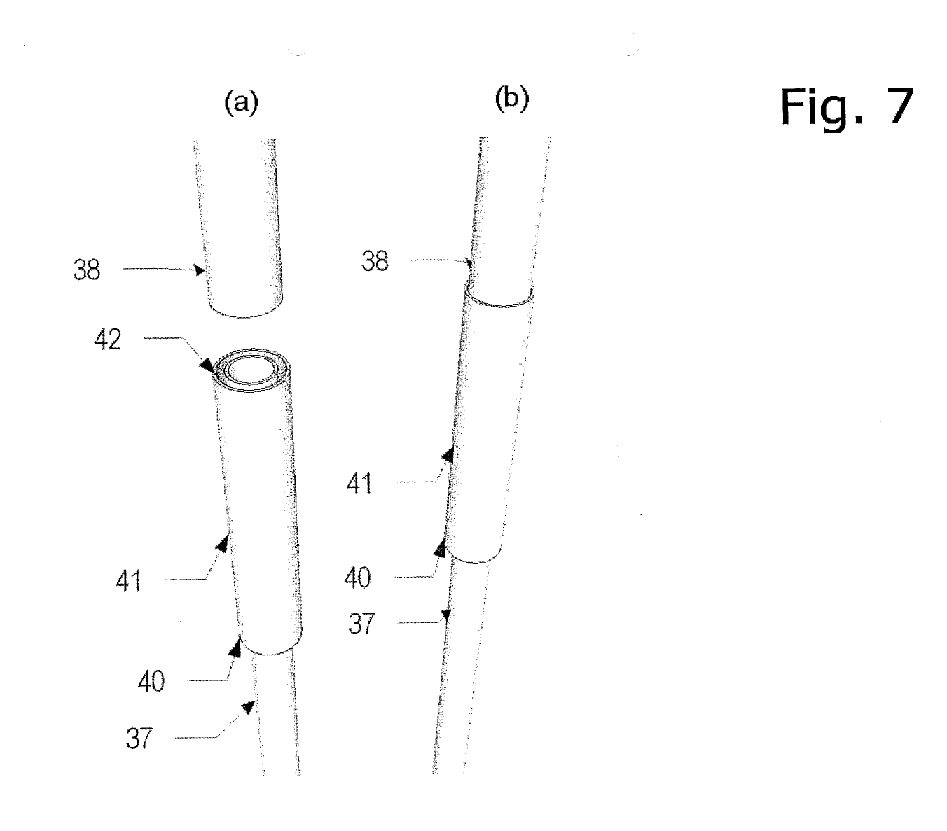

The first and second sections 37, 38 are joined for example as shown in FIGS. 6 and 7. In the case of this embodiment of the joints, the first sections 37 of the tubes 4 have at a distance from one end a collar 40 protruding outwards and a tube piece 41 made of stainless steel welded on the collar. There is an annular gap 42 between the tube piece 41 and the first section 37. The second section 38 of the tube 4 is inserted into the annular gap 42 and glued in it by means of a suitable adhesive 43. The adhesive 43 is for example a ceramic adhesive.

This embodiment of the heat exchanger 3 simultaneously enables a fixing of the tubes 4 through welding, a free expandability of the tubes 4 in the longitudinal and transverse direction and a sufficient temperature resistance in the area of the heat exchanger 3 directly next to the combustion chamber 2, which receives particularly high temperatures during operation.

An openly porous, ceramic layer 44 is arranged in the free cross-section of the jacket space 24 between the two ends of the tubes 4. This is formed e.g. through a fill of ceramic particles on a grille or through a connected porous plate with holes outside of the second ends of the tubes 4.

Insulation 45 is attached on the outside of the lateral wall of the housing 13. The insulation 45 is covered on the outside by an outer housing 46.

During operation, the clean gas and the combustion air are fed to the combustion chamber 2 via the heat exchanger 3. The combustion of the educt gases in the combustion chamber 33 takes place at the beginning of the process via the gas burner 32. In the heat exchanger 3, the educt gases are preheated at a high temperature by the clean gas flowing out of the combustion chamber 2 through the first inlet 9. If necessary, a second mass flow is removed via the valve 29, 30 and an energy conversion is performed, for example.

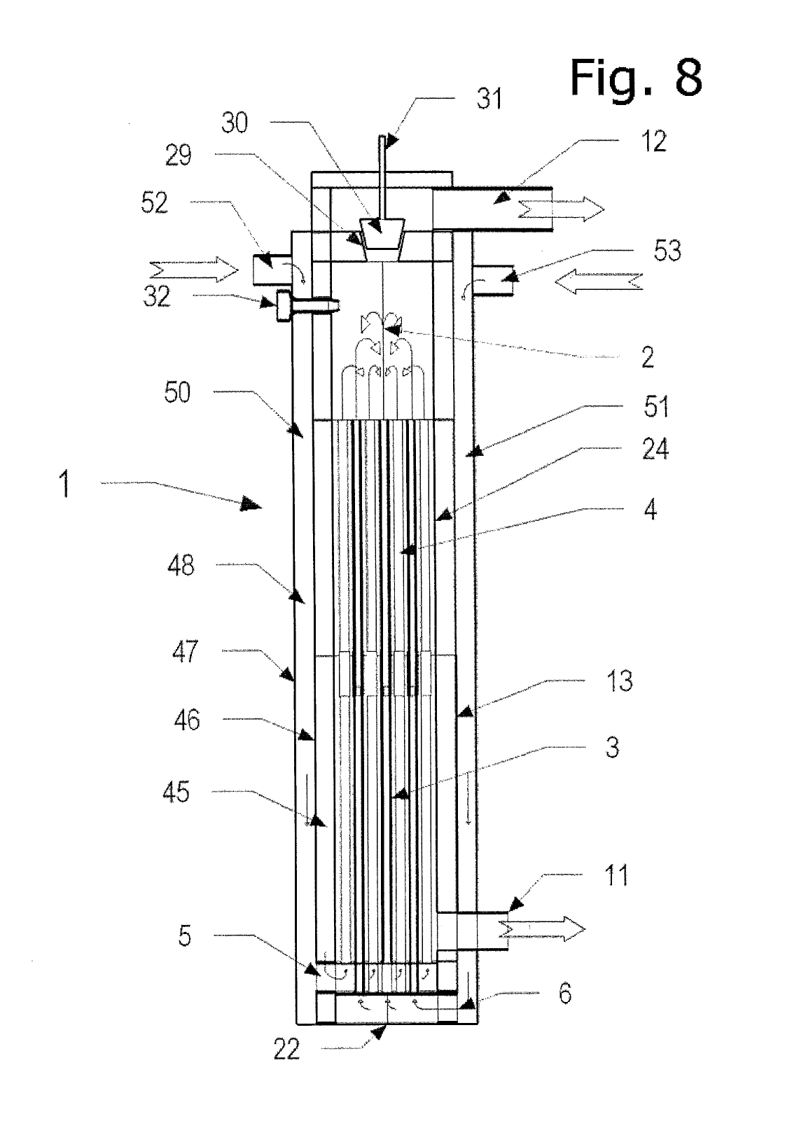

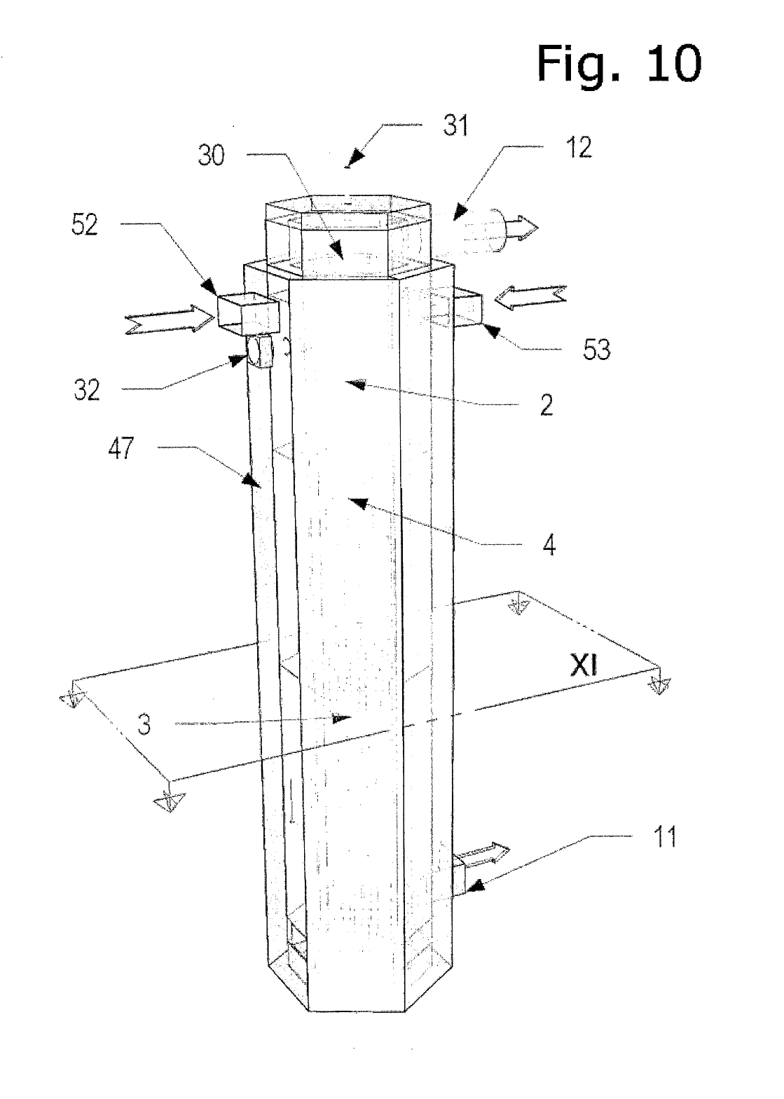

The device 1 in FIGS. 8 and 10 differs from that described above for one in that the housing 13 has a hexagonal cross-section. This cross-sectional shape favours an arrangement of several reactors next to each other in the tightest spaces and thus the modular structure of systems for thermal post-combustion.

Another difference between this design and that described above is that the housing 13 has a jacket housing 47, which is arranged at a distance around the outer housing 46 and forms a double jacket 48 with it. The double jacket 48 is divided on opposite-lying sides of the housing by two vertically progressing separating walls 49 into two separate first and second jacket chambers 50, 51.

The double jacket 48 extends in the longitudinal direction of the reactor from the combustion chamber 2 up to the inlets 5, 6 of the heat exchanger 3 for clean gas and combustion gas. On top, the first jacket chamber 50 of the double jacket 48, which is connected on the bottom with the inlet 5 of the heat exchanger 3 for clean gas, is connected with an outwards directed additional inlet 52 for clean gas. Furthermore, the second jacket chamber 51, which is connected on the bottom with the inlet 6 of the heat exchanger 3 for combustion air, is connected with an outwards directed additional inlet 53 for combustion air.

During operation, clean gas and combustion air are fed through the additional inlets 52, 53 of the reactor and are preheated en route to the inlets 5, 6 of the heat exchanger 3 by heat emitted from the outer housing 46. Another preheating takes place in the already described manner in the heat exchanger 3. The efficiency of the device for thermal post-combustion is hereby increased further.

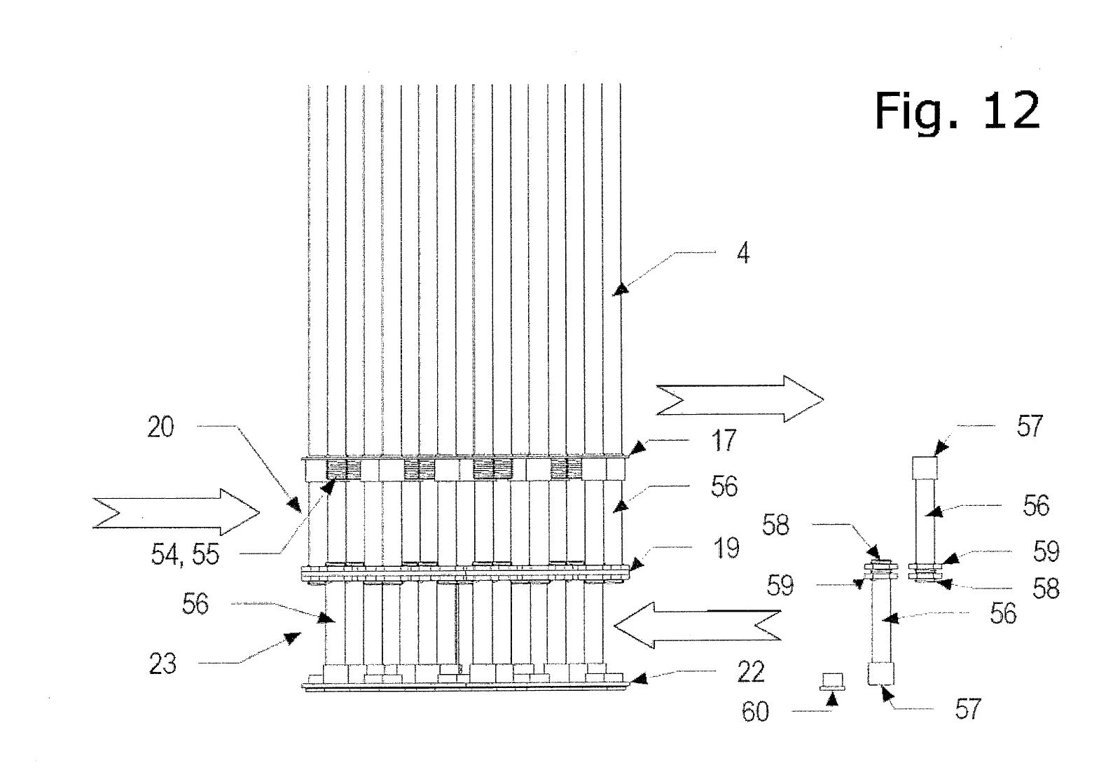

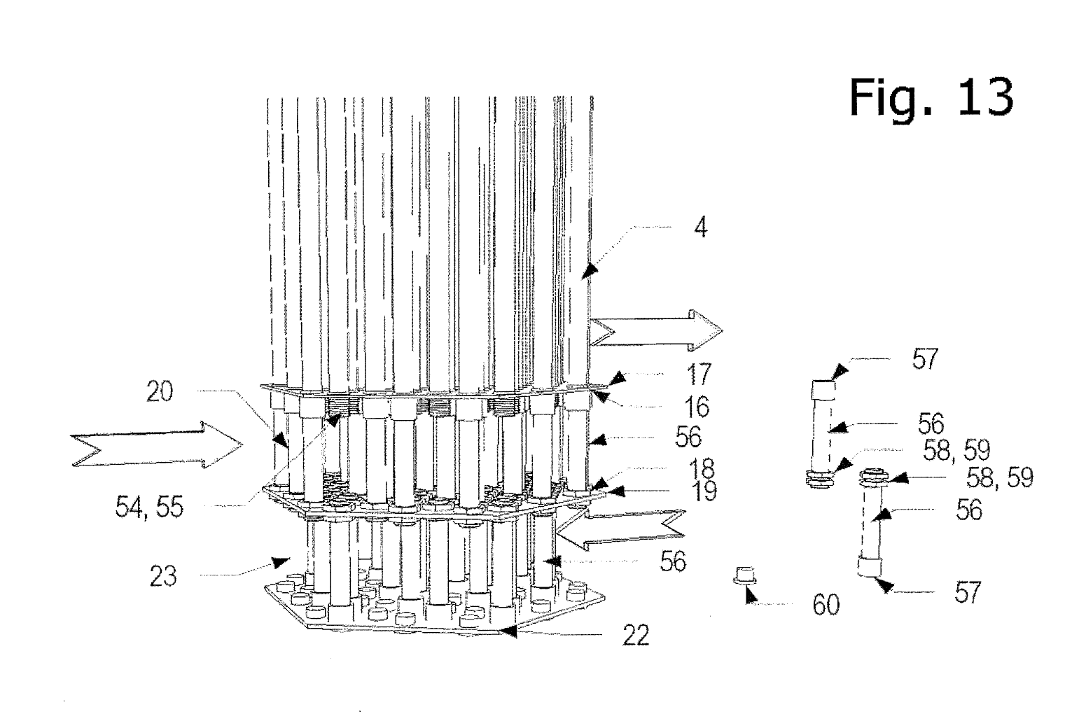

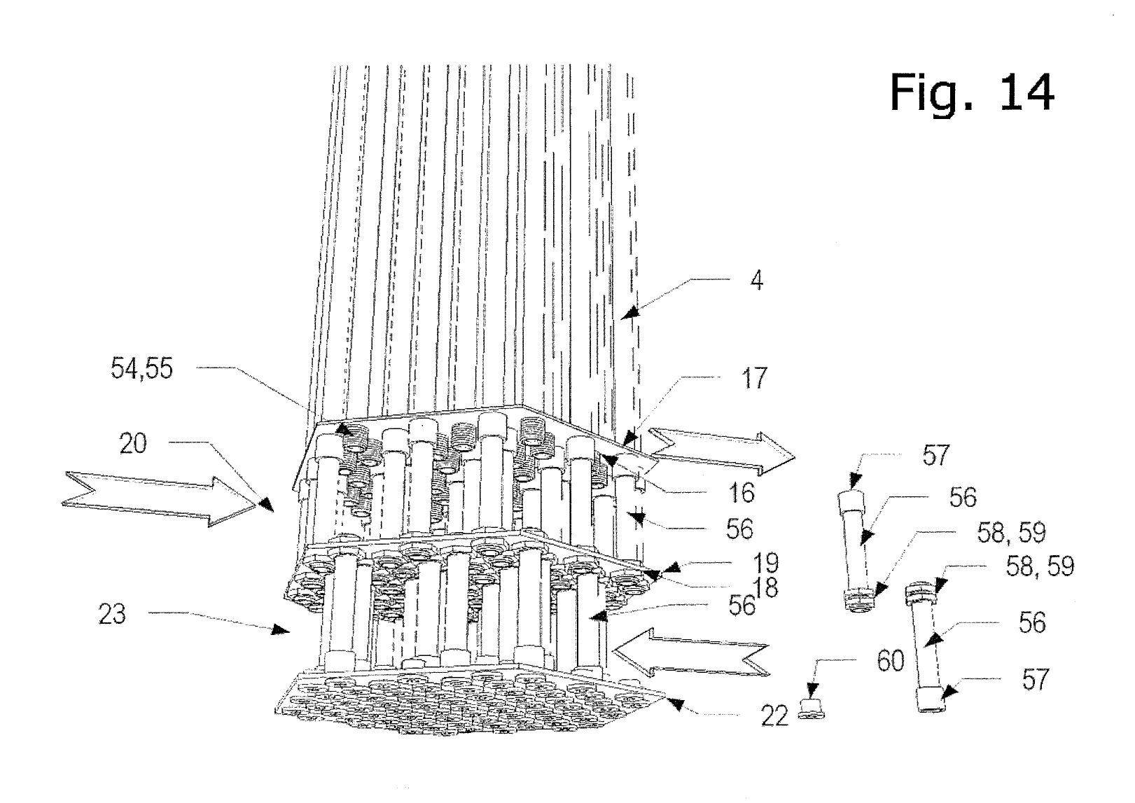

The design in FIG. 12 through 14 enables a flexible distribution of clean gas and combustion air to the tubes 4 of the heat exchanger 3 so that an adjustment can be easily made for different mass flows.

For this, the tubes 4 of both groups 14, 15 are inserted and welded on their first end into the first holes 16 of the first perforated plate 17. Furthermore, the tubes 4 have a short threaded section 54 with an external thread 55, which protrudes on the bottom from the first perforated plate 17.

The second perforated plate 19 has two holes 18, which are flush with the first holes 16 and are not filled at first.

Furthermore, extension fittings 56 are present, which have an internal thread 57 on one end, which can be screwed onto the external thread 55. Moreover, the extension fittings 56 have on the other end an additional external thread 58, onto which for example two nuts 58 and if applicable sealing washers can be screwed.

The length of the extension fittings 56 is measured such that it can be inserted with the one end into the second holes 18 of the second perforated plate 19 and can be screwed with the internal thread 57 on the other end onto the external thread 55 of the tubes. The extension fittings 56 can be fixed on the second perforated plate 19 by means of the nuts 59.

Through the screw connection or if applicable additional sealing means, the extension fittings 56 can be connected in a sealing manner on the one end with the external thread 55 of the tubes 4 and on the other end with the second perforated plate 19.

A freely selectable part of the tubes 4 of the heat exchanger 3 can thus be connected with the second distributor space 23 for the combustion air through the extension fittings 56. The tubes not screwed with extension fittings 56 in the manner described above flow into the first distributor space 20 for clean gas. The second holes 18 not filled in the manner described above are closed by means of extension fittings 55 in that they are inserted from below with their additional external threads 58 into the second holes 18 and fixed in the second holes 18 by means of the nuts 59. Alternatively, the second holes 18 are closed by means of separate sealing plugs 60.

Through this structure, the number of tubes 4 of the heat exchanger 3 for clean gas as well as for the combustion air can be adjusted based on respective needs, in particular for the content of the clean glass to be post-combusted of combustible hydrocarbons and the mass flows as well as the ratios of the mass flows of clean gas and combustible air.

Furthermore, it is possible to reach the bottom openings of the tubes 4 from below by removing sealing plug 60 or respectively extension fittings 56 in order to be able to perform cleaning work from here, for example to inspect or purge the tubes.

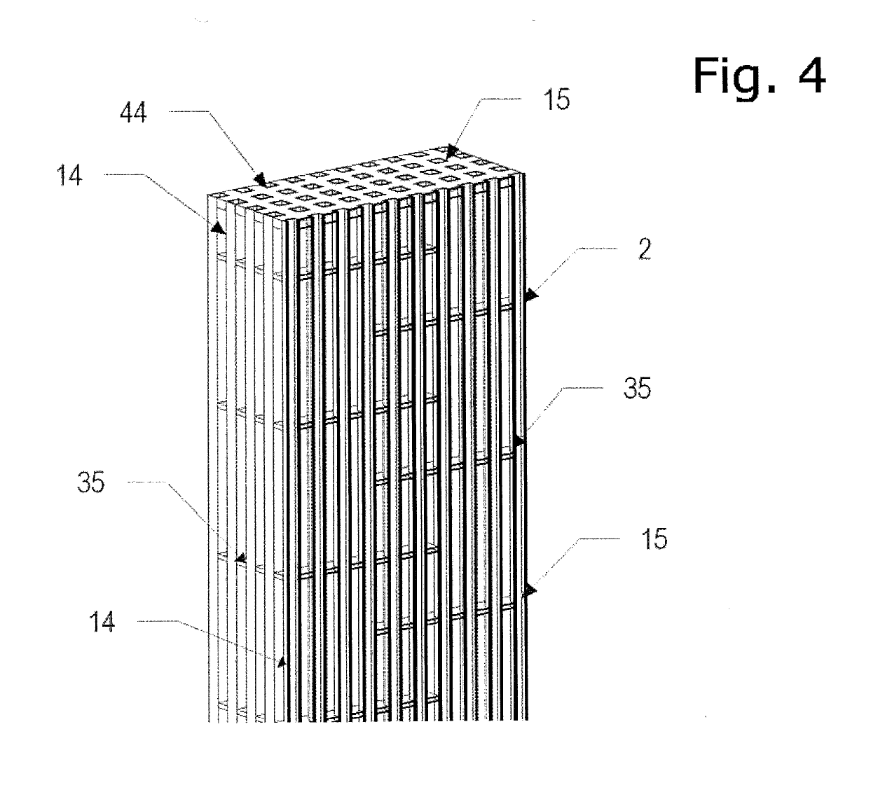

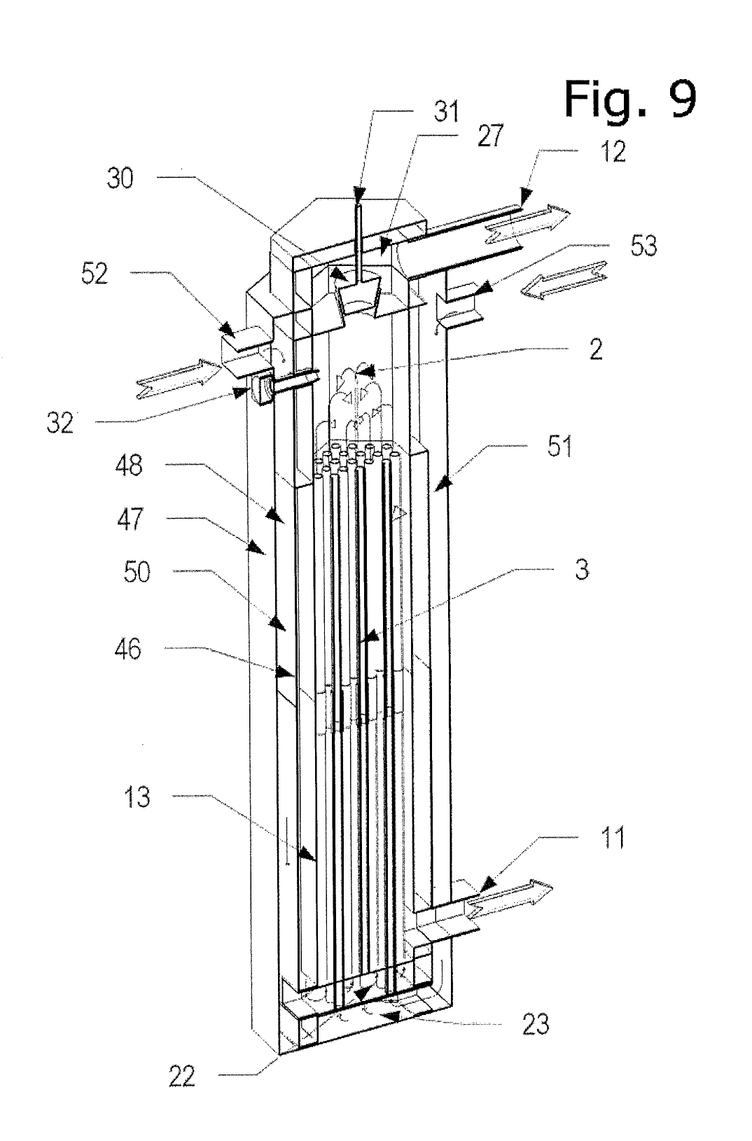

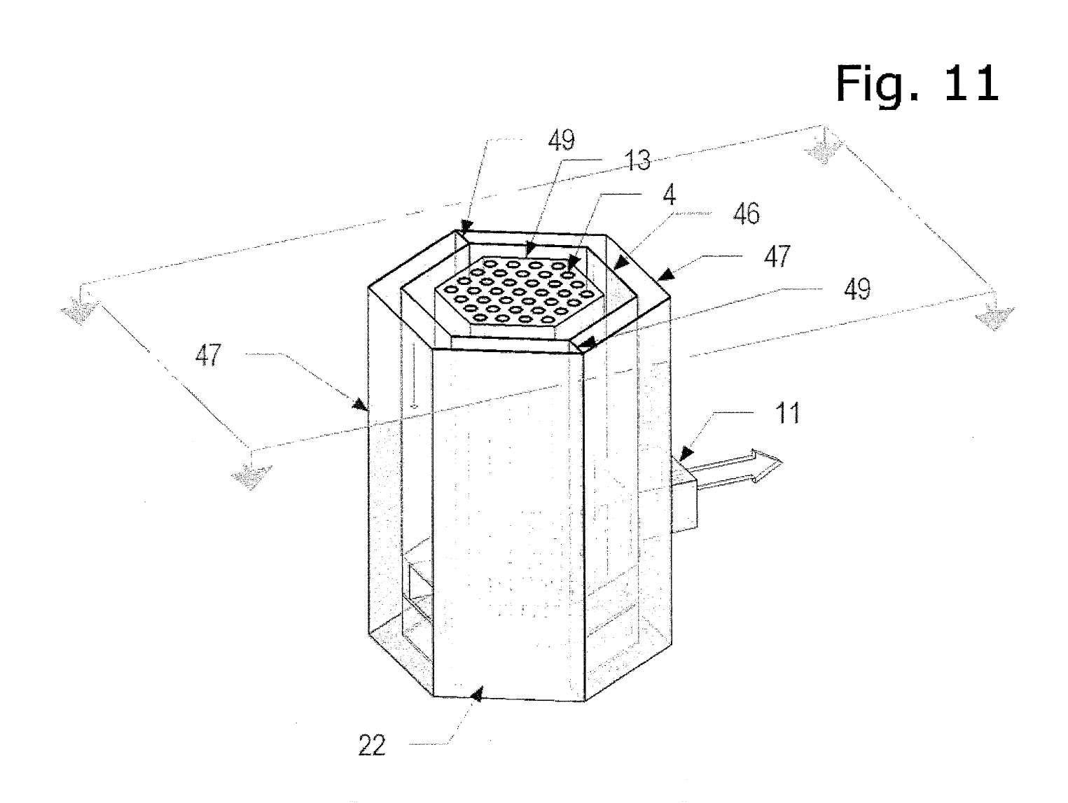

The devices 1 according to FIG. 1 through 7 or FIG. 8 through 11 can be designed according to FIG. 12 through 14.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for the thermal post-combustion of waste gases from incomplete combustion or furnace processes, low temperature carbonization gases, landfill gases, smoke gases from ceramic furnace processes, gases from household waste or bio composting facilities, lean gases or other hydrocarbon-containing reducing gases by means of air or other oxidant gases, in which the reducing gas and the oxidant gas are fed separately to the post-combustion in a combustion chamber and thermally post-combusted in the combustion chamber and the reducing gas is heated in a recuperative manner during the supply to the combustion chamber through hot clean gas thermally post-combusted and conveyed out of the combustion chamber, wherein both the reducing gas as well as the oxidant gas are heated in a recuperative manner flowing parallel via the separate supply to the combustion chamber by the hot clean gas conveyed out of the combustion chamber.

2. The method according to claim 1, in which the reducing gas and the oxidant gas are heated in a recuperative manner until their introduction into the combustion chamber by the clean gas conveyed out of the combustion chamber.

3. The method according to claim 1, in which the reducing gas and the oxidant gas are heated in a recuperative manner by the same mass flow of the clean gas conveyed out of the combustion chamber.

4. The method according to claim 1, in which the reducing gas and the oxidant gas are heated in a recuperative manner flowing vertically upward through the clean gas conveyed out of the combustion chamber, wherein the reducing gas and the oxidant gas are heated during their separate supply into the combustion chamber by the clean gas conveyed out of the combustion chamber in the counterflow or in the cross counterflow.

5. The method according to claim 1, in which in order to start the post-combustion the combustion chamber is preheated at least to a temperature above the ignition temperature of the educt gas mixture by an electrical resistance heater or another heating device and/or by a gas burner or another firing device in order to start the post-combustion.

6. The method according to claim 1, in which a second partial flow of the hot clean gas is conveyed out of the combustion chamber separately from a first partial flow of the hot clean gas conveyed out of the combustion chamber for the recuperative heating of the educt gases in order to set the pressure and the temperature in the combustion chamber, and/or the second partial flow of the hot clean gas is fed to a downstream energy converter for conversion of thermal energy into mechanical or electrical energy.

7. The method according to claim 1, in which the clean gas from the combustion chamber is conveyed away through an openly porous, ceramic layer, which on one hand reduces the thermal radiation from the combustion chamber into the cableway of the clean gas, on the other hand improves the combustion in the combustion chamber, in that, in its pore structure, a strong swirling at a simultaneously high temperature finally completes the oxidation of the reducing gas before the thermally post-combusted clean gas is fed to the recuperative heating of the educt gases.

8. A device for the thermal post-combustion of waste gases from incomplete combustion or furnace processes, low temperature carbonization gases, landfill gases, smoke gases from ceramic furnace processes, gases from household waste or bio composting facilities, lean gases or other hydrocarbon-containing reducing gases by means of air or other oxidant gases with a combustion chamber (2), which has separate inlets (5, 6) for reducing gas and the oxidant gas and an outlet (9) for thermally post-combusted hot clean gas, and at least one recuperative heat exchanger (3) with at least one primary-side flow channel (24), the inlet (10) of which is connected with the outlet (9) for hot clean gas of from the combustion chamber (2), and at least one secondary-side flow channel (14), which has an inlet (5) for the reducing gas and an outlet (7), which is connected with the inlet of the combustion chamber (2) for reducing gas, wherein the recuperative heat exchanger (2) has at least one secondary-side flow channel (15) for the oxidant gas, which has an inlet (6) for the oxidant gas and an outlet (8), which is connected with the inlet for the oxidant gas from the combustion chamber (2).

9. The device according to claim 8, in which for operation of the heat exchanger (3) in the counterflow an inlet (24) of at least one primary flow channel (24), which neighbours the outlets (7, 8) of the secondary flow channels (14, 15), is connected with the outlet of the combustion chamber (2) for hot clean gas and the outlets (7, 8) of the secondary-side flow channels (14, 15) are connected directly with the inlets for educt gases of the combustion space (2) and the inlet (10) of the primary-side flow channel (24) is connected directly with the outlet (9) of the combustion chamber (2) for hot clean gas.

10. The device according to claim 8, in which the heat exchanger (3) in a housing (13) has parallel, straight tubes (4), of which a first group (14) with its openings on a first end flows into a first distributor space (20) for the reducing gas, which has the inlet (5) for the reducing gas, and with its openings on a second end flows into the combustion chamber (2), of which a second group (15) with its openings on a first end flows into a second distributor space (23) for the oxidant gas, which has an inlet (6) for oxidant gas, and with its openings on a second end flows into the combustion chamber (2), and in which the jacket space (24) between the parallel tubes (4) and the housing (13) on a first end are connected with the combustion chamber (2) via an opening and has on a second end an outlet (11) for cooled clean gas, the combustion chamber (2) and the heat exchanger (3) are combined into one structural unit.

11. The device according to claim 8, in which the combustion chamber (2) has a second outlet (12) for hot clean gas and a valve (29, 30) connected with the second outlet (12) for setting the mass flow flowing from the second outlet (12).

12. The device according to claim 10, in which the tubes (4) of the heat exchanger (3) have sections (37), which are made of stainless steel tubes and are welded in a gas-tight manner in holes of perforated plates (17, 19), which border the distributor spaces (20, 23) for the reducing gas and the oxidant gas, wherein the first perforated plate (17) bordering the first distributor space (20), onto which the clean gas flows before exiting the outlet for clean gas, is provided with a ceramic insulation so that the first perforated plate (17) as well as the welding points are protected from thermal stress and chemically corrosive interference.

13. The device according to claim 8, in which the tubes (4) have two sections (38) flowing into the combustion chamber (2), which are made of gas-tight, silicon-infiltrated silicon carbide (SiC), which preferably withstand temperatures of up to 1360° C. and can freely expand in length since these sections (38) of the tubes (4) are each only fixed at one position in their longitudinal direction and can otherwise freely expand in their longitudinal direction.

14. The device according to claim 12, in which the first sections (37) of the tubes (4) made of stainless steel and the second sections (38) of the tubes (4) made of SiC are aligned coaxially with respect to each other and are permanently interconnected on one end, wherein the joint (40) between the first sections (37) of the tubes (4) made of stainless steel and the second sections (38) of the tubes (4) made of SiC comprises a collar (41) protruding outwards from the first sections (37) at a distance from one end and a tube piece (42) welded on the collar (41) made of stainless steel with an annular gap (43) between the tube piece (42) and the first section (37), wherein the second sections (38) with their end areas are inserted into the annular gaps (43) and are mounted on the collar (41).

15. The device according to claim 8, in which an openly porous, ceramic layer (44) closes a lower part of the combustion chamber (2), into which the tubes (4) with the openings on their first ends flow, on one hand in order to minimize the direct thermal radiation from the combustion chamber (33) into the area around the tubes (4) and on the other hand to improve the combustion taking place in the combustion chamber (33) in that, in the pore structure of the ceramic layer, strong swirlings at a simultaneously high temperature finally complete the oxidation of the reducing gas before the clean gas is conveyed away to the educt gases around the tubes (4) in the counterflow and, if applicable, by means of baffles (35) in the cross counterflow.
